(19) United States
(12) Patent Application Publication
(10) Pub. No.: US 2016/0192314 A1
(43) Pub. Date: Jun. 30, 2016

(54) Positioning Method and Apparatus and Computer Program Product

(71) Applicants: Jussi LEPPÄNEN, Tampere (FI); Antti ERONEN, Tampere (FI); Jussi PARVIAINEN, Pirkkala (FI); Jussi COLLIN, Viiala (FI)

(72) Inventors: Jussi LEPPÄNEN, Tampere (FI); Antti ERONEN, Tampere (FI); Jussi PARVIAINEN, Pirkkala (FI); Jussi COLLIN, Viiala (FI)

(73) Assignee: Nokia Corporation, Espoo (FI)

(21) Appl. No.: 14/380,364

(22) PCT Filed: Feb. 27, 2012
(86) PCT No.: PCT/FI2012/050193

§ 371 Date: Nov. 11, 2014

(51) Int. Cl. H04W 64/00; H04W 4/02; G01S 5/02

(52) U.S. Cl. CPC H04W 64/00; G01S 5/0278; G01S 5/0252; H04W 4/02; H04W 84/12

(57) ABSTRACT

Various embodiments concern positioning. The method comprises receiving information relating to radio fingerprint of an apparatus from at least two apparatuses (103); determining estimated positions of said at least two apparatuses according to received information (104); selecting an apparatus from said at least two apparatuses (105); requesting information relating to position of the selected apparatus (106); and iterating the steps for determining, selecting and requesting until estimated positions are determined to be reliable (104-109). In a method for sharing information between devices for positioning purposes nearby device names are scanned and an own name field is modified so that the name field contains information on the scanned nearby device names.

### TECHNICAL FIELD

The present application relates generally to positioning.

### BACKGROUND

Position information is utilized greatly by various services and applications. Position information outdoors can be obtained by means of GPS (Global Positioning System) signals, however position information indoors (e.g. IPS, Indoor Positioning System) typically utilizes nodes inside buildings to determine the position of the user.

### SUMMARY

Various aspects of examples of the invention are set out in the claims.

According to a first aspect of the present invention, the method comprises receiving information relating to radio fingerprint of an apparatus from at least two apparatus; determining estimated positions of said at least two apparatus according to received information; selecting an apparatus from said at least two apparatus; requesting information relating to position of the selected apparatus user; iterating the steps for determining an estimated position, selecting a user and requesting a position until estimated positions are determined to be reliable.

According to an embodiment the method comprises determining which apparatus has the least reliable estimated position and selecting such an apparatus from said at least two apparatus.

According to an embodiment the method comprises requesting the selected apparatus to indicate its position in the form of an identification of a grid cell.

According to an embodiment the method comprises requesting the selected apparatus to indicate its position in the form of radio fingerprint.

According to an embodiment the method comprises receiving information in the form of user input.

According to an embodiment the radio fingerprint data is formed of any of the following elements independently or in combination: one or more device addresses used for one or more type of data transmission, one or more signal strengths relating to certain data transmission method.

According to an embodiment the method comprises forming a matrix comprising the received fingerprints of said at least two apparatus relating to a certain data transmission method in order to determine the estimated positions of the apparatuses.

According to an embodiment for determining that the estimated positions are reliable, the method comprises i) creating position probability matrices for said at least two apparatus, which position probability matrices relate to a certain data transmission method indicating the estimated position for said at least two apparatus, ii) determining mean matrix for said at least two apparatus by means of the position probability matrices, and repeating steps i) and ii) until probabilities for unknown positions are above a threshold.

According to an embodiment the information relating to radio fingerprints or position is shared between said at least two apparatus by modifying apparatuses' names to comprise information on radio fingerprints of surrounding apparatuses, and repeating this until information relating to each apparatus of said at least two apparatus has been obtained

According to a second aspect of the present invention, a method for sharing information between devices for positioning purposes, comprises scanning nearby device names and modifying an own name field so that the name field contains information on the scanned nearby device names.

According to an embodiment the method comprises modifying the own name field with a received signal strength indicator value of the scanned devices.

According to an embodiment the method comprises modifying the own name field with a classified motion mode of the scanned devices.

According to an embodiment the method comprises modifying the own name field by copying the name fields of the scanned devices.

According to an embodiment the method comprises removing duplicates of the copied names fields from the own name field.

According to an embodiment the method comprises finding links between devices and modifying the own name field with links to the scanned devices.

According to a third aspect of the present invention, an apparatus comprises a processor configured to receive information relating to radio fingerprint of an apparatus from at least two apparatus; determine estimated positions for said at least two apparatuses according to received information; select an apparatus from said at least two apparatus; request information relating to position of the selected apparatus; iterate determining estimated position, selecting an apparatus and requesting position information until estimated positions are determined to be reliable.

According to a fourth aspect of the present invention, an apparatus comprises at least one processor; and at least one memory including computer program code, the at least one memory and the computer program code configured to, with the at least one processor, cause the apparatus to perform at least the following: receiving information relating to radio fingerprint of an apparatus from at least two apparatus; determining estimated positions of said at least two apparatus according to received information; selecting an apparatus from said at least two apparatus; requesting information relating to position of the selected apparatus user; iterating the steps for determining an estimated position, selecting a user and requesting a position until estimated positions are determined to be reliable.

According to a fifth aspect of the present invention, an apparatus comprises at least one processor; and at least one memory including computer program code; the at least one memory and the computer program code configured to, with the at least one processor, cause the apparatus to perform at least the following: scanning nearby device names; modifying an own name field so that the name field contains information on the scanned nearby device names; in order to share information between devices for positioning purposes.

According to a sixth aspect of the present invention, a computer program comprises code for receiving information relating to radio fingerprint of an apparatus from at least two apparatus; code for determining estimated positions of said at least two apparatus according to received information; code for selecting an apparatus from said at least two apparatus; requesting information relating to position of the selected apparatus user; code for iterating the steps for determining an estimated position, selecting a user and requesting a position until estimated positions are determined to be reliable when the computer program is run on a processor.

According to a seventh aspect of the present invention, a computer-readable medium encoded with instructions that, when executed by a computer, perform: receiving information relating to radio fingerprint of an apparatus from at least two apparatus; determining estimated positions of said at least two apparatus according to received information; selecting an apparatus from said at least two apparatus; requesting information relating to position of the selected apparatus user; iterating the steps for determining an estimated position, selecting a user and requesting a position until estimated positions are determined to be reliable.

### BRIEF DESCRIPTION OF THE DRAWINGS

For a more complete understanding of example embodiments of the present invention, reference is now made to the following descriptions taken in connection with the accompanying drawings in which:

FIG. 1 shows a block diagram of the system functionality according to an embodiment;

FIGS. 2A, 2B show examples of “far” and “close” grid cells for a 3×3 grid;

FIG. 3 shows an example of 3×3 grid over a rock club;

FIG. 4 shows an example on how user feedback can be asked and given during the shooting of an event:

FIG. 5 shows an example of true positions of devices 1 to 8;

FIG. 6 relates to the example of FIG. 5 and shows an example on the estimated positions of the devices after one iteration of the positioning algorithm;

FIGS. 7 and 8 relate to the example of FIG. 5 and show examples of the position estimates after more iterations of the position algorithm;

FIG. 9 relates to the example of FIG. 5 and shows correct positions of the devices after four iterations;

FIG. 10 shows an average accuracy of the position estimates;

FIG. 11 shows an example for sharing information between four devices;

FIGS. 12A and 12B show an example where links between devices 1 to 8 are tracked;

FIGS. 13A, 13B show first two iterations from the point of view of Device 1,

FIG. 14 shows a schematic block diagram of an apparatus according to an embodiment;

FIG. 15 shows a further embodiment of an apparatus; and

FIG. 16 shows an example of a system.

### DETAILED DESCRIPTION

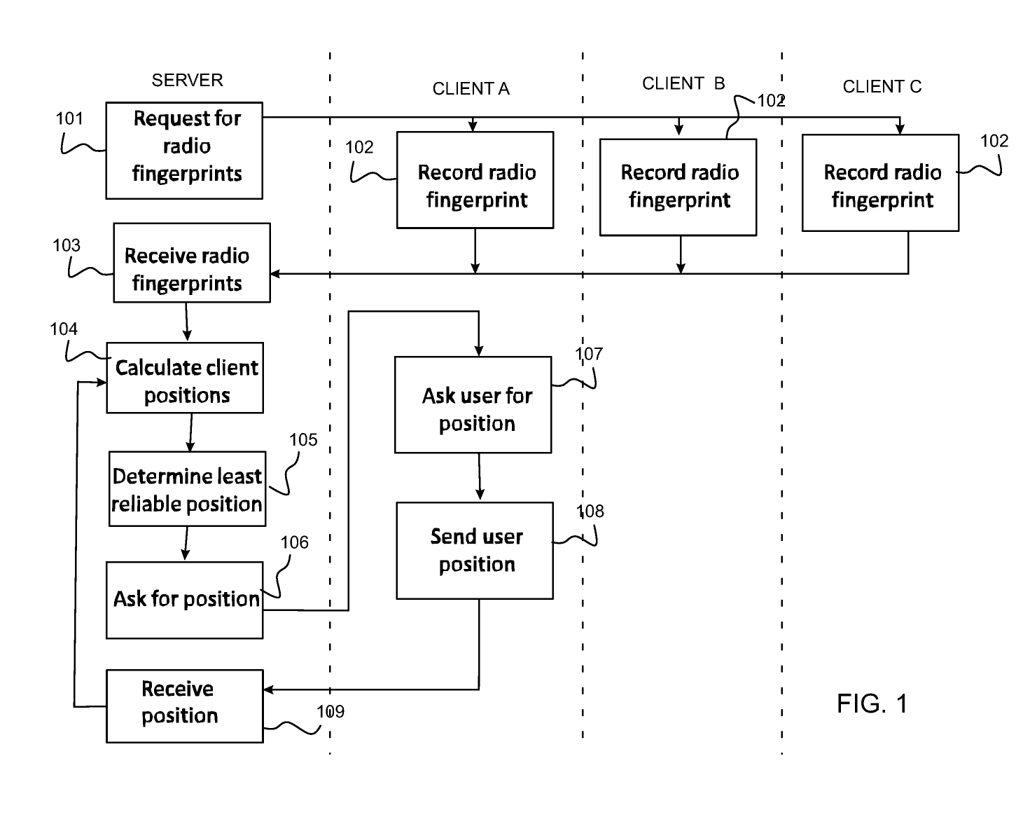

Some example embodiments of the present invention and its potential advantages are understood by referring to FIGS. 1 to 16.

The following embodiments relate to a collaborative indoor positioning in an N by M grid. Improving indoor positioning accuracy can be done by asking for user feedback (i.e. position information) iteratively from one user at a time. In an embodiment, the apparatus may provide the position information without input from the user. In an embodiment, at each iteration the user whose estimated position is determined to be the least reliable, may be asked to provide feedback. Once all positions are determined to be reliable enough, no more feedback is necessarily needed. Such a system minimizes the number of times feedback is needed to be asked from the users.

An embodiment of the solution may be implemented on a client/server based relative indoor positioning system. The server is configured to calculate the relative position of the clients using radio fingerprint data collected from the clients. Radio fingerprint relates to a unique fingerprint of a wireless device, which fingerprint characterizes devices signal transmission. Some clients are asked to provide their positions to improve the accuracy of the system. The system works on an N×M grid, meaning that the actual positions may not be calculated but instead the position may be given as an identification to a specific grid cell. Also, the user provided positions may be given with respect to the grid cells.

FIG. 1 shows a block diagram of the system functionality according to an embodiment. In this embodiment, the system comprises a server and three clients: Client A, Client B and Client C. It is appreciated that in an embodiment, apparatus (also called as a device or a terminal) is associated with a user. In such embodiment, identifying a position of the apparatus may correspond to identifying position of the user associated with the apparatus.

At first the server is configured to request (101) the radio fingerprints of the clients. These radio fingerprints are used as input by the server positioning algorithm.

The clients A, B, C receive the request for radio fingerprints, after which they are configured to perform a scan of the radio (e.g. Bluetooth®, wireless local area network (WLAN)) environment in order to compose the radio fingerprint (102). The radio fingerprint of a client may be composed of Bluetooth and WLAN device addresses and signal strengths that the client is able to scan. The radio fingerprint of a client may also be composed of only one or any combination of the previous options (Bluetooth device address, WLAN device address, one or more signal strength). After having composed the radio fingerprints, the clients send them to the server.

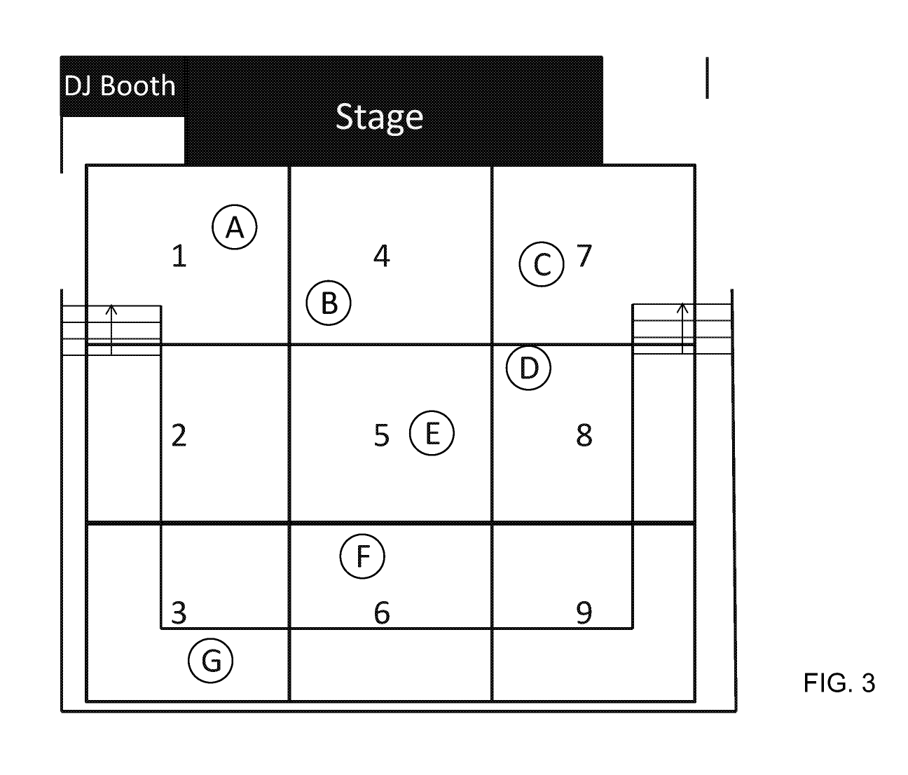

After receiving (103) the radio fingerprints, the server is configured to run the positioning algorithm. The positioning algorithm works on an N×M grid over the space where the positioning is to be done. FIG. 3 shows an example of 3×3 grid over a rock club. In some embodiments, an identification of the grid (grid ID) where the user is being located may be of interest. Also, the feedback on the position may be provided at the grid level. In FIG. 3, for example, the position determined for user A should be grid 1.

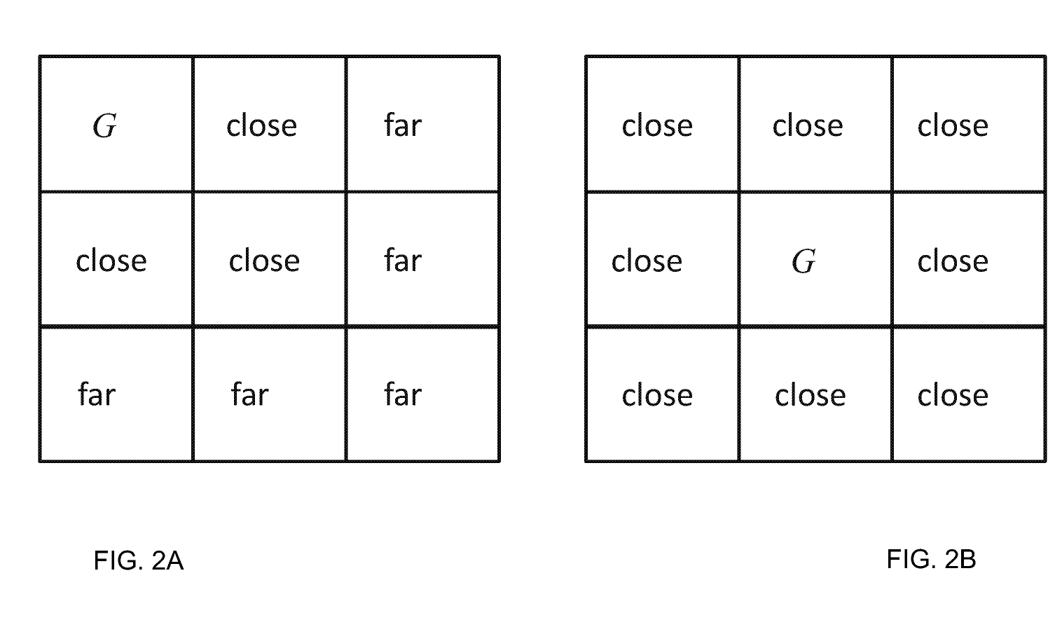

The positioning algorithm takes as input the radio fingerprints of the devices. Positions are determined (104) as follows:
1. Matrix S^{BT} of Bluetooth signal strengths is created:

$${S}^{BT} = [ \begin{matrix}0 & {s}_{1 , 2}^{BT} & … & {s}_{1 , C}^{BT} \\ {s}_{2 , 1}^{BT} & 0 & … & {S}_{2 , C}^{BT} \\ ⋮ & ⋮ & ⋱ & ⋮ \\ {s}_{C , 1}^{BT} & {s}_{C , 2}^{BT} & … & 0\end{matrix} ] ,$$

where s_{i,j}^{BT} is the Bluetooth signal strength of device i recorded by device j in dBm and C is the total number of clients.
2. Matrix S^{WLAN} of WLAN signal strengths is created:

$${S}^{WLAN} = [ \begin{matrix}{s}_{1 , 1}^{WLAN} & {s}_{1 , 2}^{WLAN} & … & {s}_{1 , C}^{WLAN} \\ {s}_{2 , 1}^{WLAN} & {s}_{2 , 2}^{WLAN} & … & {s}_{2 , C}^{WLAN} \\ ⋮ & ⋮ & ⋱ & ⋮ \\ {s}_{W , 1}^{WLAN} & {s}_{W , 2}^{WLAN} & … & {s}_{W , C}^{WLAN}\end{matrix} ] ,$$

where s_{i,j}^{WLAN} is the WLAN signal strength of WLAN station i recorded by device j in dBm and C is the total number of clients and W is the total number of WLAN stations heard by all of the clients. If a WLAN station is not heard by a client, the corresponding value in S^{WLAN} is set to −97 dBm.
3. A client d is picked, either
   a. picking the client d randomly In the beginning of the algorithm, or
   b. in the latter iterations of the algorithm, client d may be picked as the one whose position probability is smallest (105). This is explained in more detail later.
      After having picked the client d a request to provide its position is sent to it (106, 107). The position may be returned (108, 109) as a grid cell index G. The set of known device indices is denoted as D. Optionally, the client could perform a radio network scan and return also updated radio fingerprint information.
4. “Close” and “far” grid cells are determined with respect to grid cell index G. Which grids are “close” and which are “far” depend on the number of rows and columns in the grid. FIGS. 2a and 2b illustrate examples of “far” and “close” grid cells for a 3×3 grid.
5. Position probability matrices for all clients are created based on S^{BT}, G and D and d. This may be done as follows:
   a. Determine the range R^{d} of the Bluetooth device signal strengths recorded by client d:

$${R}^{d} = {max}_{i} {s}_{i , d}^{BT} - {min}_{i} {s}_{i , d}^{BT}$$

b. Normalize Bluetooth signal strengths recorded by client d as follows:

$${N}_{i , d}^{BT} = \frac{{s}_{i , d}^{BT} - {min}_{i} {s}_{i , d}^{BT}}{{R}^{d}} , i = 1 … C$$

c. The value of each N_{i,d}^{BT} is between 0 and 1. They can thus be interpreted as probabilities. More specifically, N_{i,d}^{BT} can be interpreted to be the probability of client i being in a “close” grid cell with respect to client d. 1−N_{i,d}^{BT} can thus be the probability of client i being in a “far” grid cell with respect to client d.
d. Based on above, the position probability matrices P^{k} for all clients k=1 . . . C can be created, whose elements are defined as follows:

$${P}_{i , j}^{k} = \{ \begin{matrix}\frac{1}{\vert D \vert} {\sum }_{d ∈ D} {N}_{i , d}^{BT} , & ( i , j ) = ' close ' \\ \frac{1}{\vert D \vert} {\sum }_{d ∈ D} ( 1 - {N}_{i , d}^{BT} ) , & ( i , j ) = ' far '\end{matrix}$$

For devices d in the set D this is not needed since their position is known. The “close” grid cells (i, j) are those which are adjacent to the grid cell G and remaining cells are “far” (see step 4). Thus, the clients in D with the known positions can be considered as “anchor devices”, and the position probability matrices are may be created based on signal strength measurements to other devices received from the devices in D.
6. Similar position probability matrices for all devices may be created based on S^{WLAN}, G and D and d.
   a. Determine a ‘WLAN distance’ E_{i,d} between device d and the other devices i:

$${E}_{i , d} = \frac{‖ ⌊ \begin{matrix}{s}_{1 , i}^{WLAN} \\ ⋮ \\ {s}_{W , i}^{WLAN}\end{matrix} ⌋ - ⌊ \begin{matrix}{s}_{1 , d}^{WLAN} \\ ⋮ \\ {s}_{W , d}^{WLAN}\end{matrix} ⌋ ‖}{{max}_{i} {s}_{i , d}^{WLAN} - {min}_{i} {s}_{i , d}^{WLAN}}$$

b. Determine position probability matrices Q^{k} for all clients in the same manner as in steps 5a to 5d above, substituting E_{i,d} for S^{BT}.
7. Now there are matrices P^{k} and Q^{k} for all clients k=1 . . . C which describe the probability of each device k, being in the different grid cells. For each device, the mean of two matrices M^{k}=(P^{k}+Q^{k})/2 are determined. The estimated location of device k is then the grid cell (m, n) of M^{k} whose probability is the highest in the respective mean matrix M^{k}. This is denoted as M_{\hat{m},\hat{n}}^{k}.
8. If the probabilities for all unknown positions are above a threshold, the positioning process can be stopped. If not, another device l, whose maximum probability M_{\hat{m},\hat{n}}^{l} is the lowest is chosen, and added to the set D. In this case steps 4 to 8 are repeated.

It is noted that although the above algorithm uses Bluetooth and WLAN signal strengths, the algorithm can also be implemented by using signal strengths from other radio receivers as well. For example, the system can use cellular receivers such as GSM (Global System for Mobile Communications), UMTS (Universal Mobile Telecommunications System), or CDMA (Code Division Multiple Access). It is also appreciated that the algorithm may be modified in various ways. Such modifications may include, for example, using a product instead of a sum when combining the matrices in the step 7, above; performing various mapping (e.g. a sigmoidal mapping or exponential mapping or other mapping which could help the algorithm performance in some situations) on the signal strength values before performing the calculations above; performing some kind of filtering to the signal strength values to reduce fluctuations; repeating the radio network scan in the client for two or more times and then using averages of signal strength values over these repeated scans to get more reliable measurements; using alternative strategies for picking the client in step 3, above, such alternative strategies including for example information theoretic methods based on, for example, various entropy or mutual information methods, which might enable picking the client leading to most information increase; using other grid cell shapes than rectangular such as for example hexagonal or circular cells, possibly allowing some overlap between adjacent cells.

The present embodiment is beneficial in, for example, a crowd-sourced video service. An example use case is related to a concert, where a crowd of users are going to. During the concert, the users shoot video of the event. After the concert, the video content is uploaded to the video service. The video service then creates an automatic cut of the video clips of the users. The video service also analyses sensory data captured by the mobile recording client to determine which are interesting points at each point in time during the event, and then makes switches between different source media in the final cut. Audio alignment is used to find a common timeline for all the source videos, and, for example, dedicated sensor data (accelerometer, compass) analysis algorithms are used to detect when several users are pointing to the same location on the stage, most likely indicating an interesting event. Furthermore, music content analysis (beats, downbeats) is used to find a temporal grid of potential cut points in the event soundtrack. When the user position is determined according to the previous embodiment, more interesting cuts can be obtained in the final output for the video service.

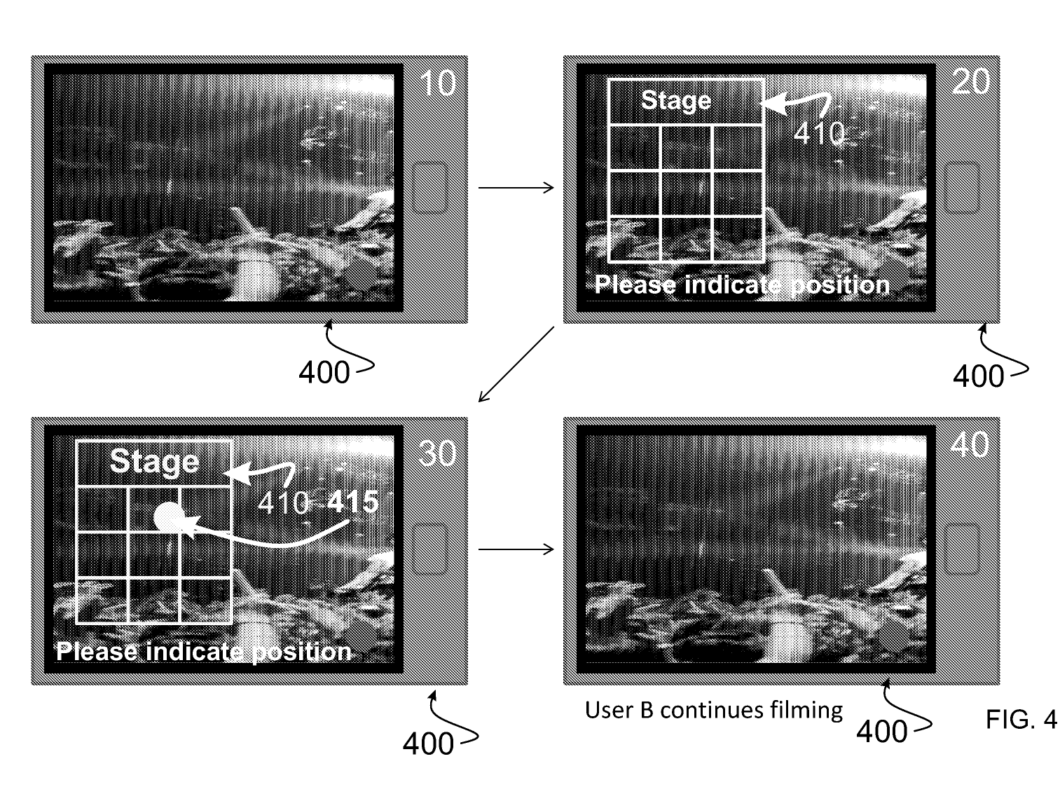

FIG. 3 shows an example of the crowd source video scenario. The event is being filmed by seven users (circles labelled A to G). A 3×3 grid is used to define the positions of the users. FIG. 4 shows how user feedback can be asked and given during the shooting of an event. At first (10), a client device B (400) shows a viewfinder image. Then (20), the user of client device B (400) is asked for a position to be indicated with a user interface input means in a user interface element (410) shown together the viewfinder image. On the following phase (30) the user of client device B (400) clicks on his/her position (415) in the user interface element. After giving the position, the user may continue filming (40) with his/her client device B (400).

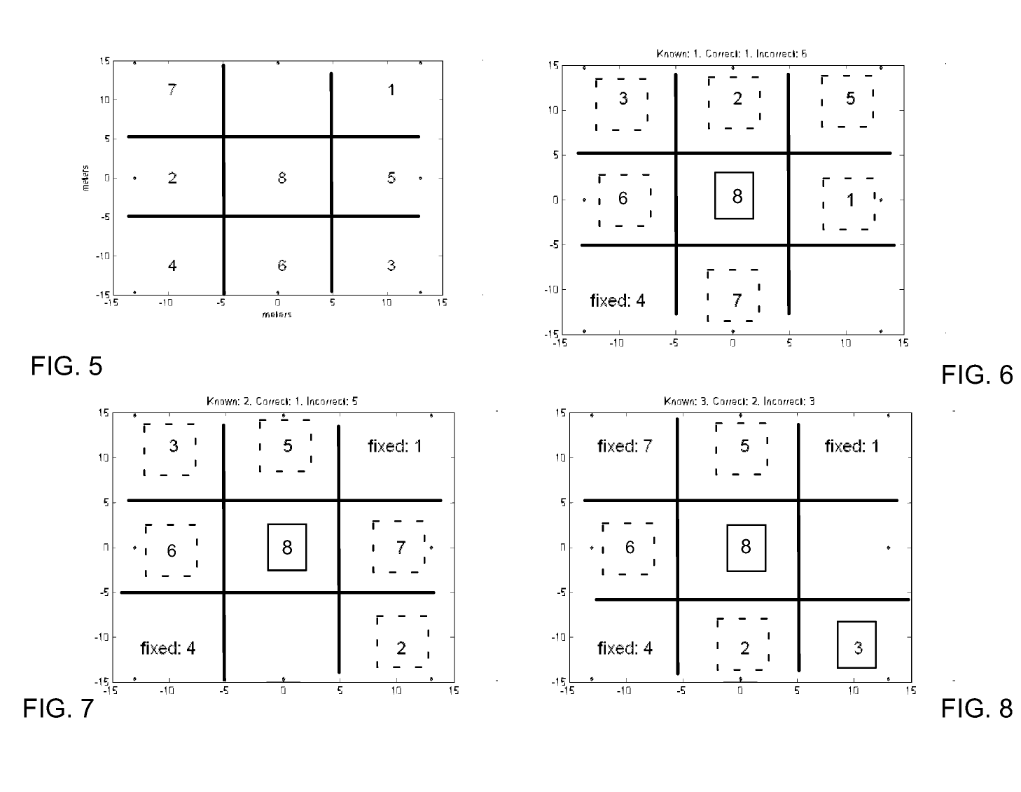

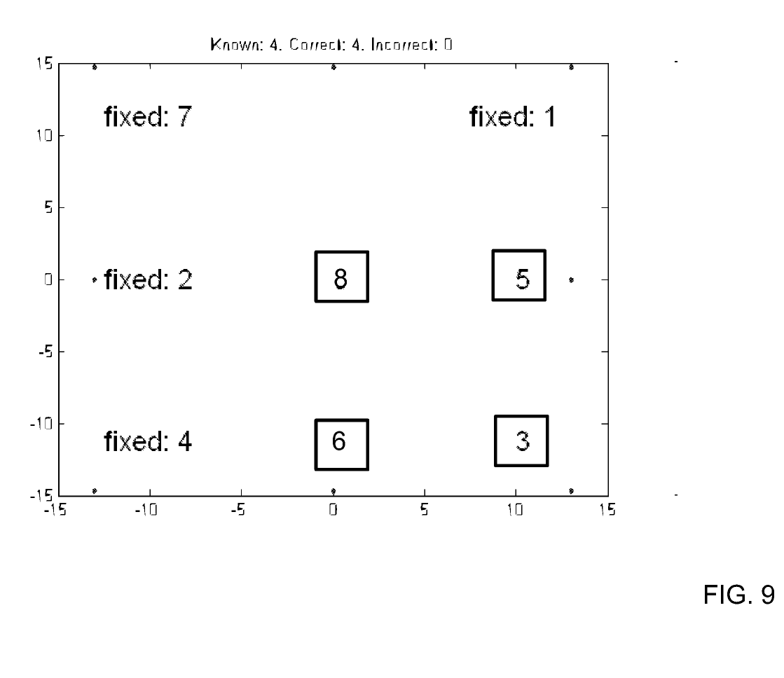

The positions of the devices (1 to 8) with respect to a 3×3 grid is shown in FIG. 5. FIG. 6 shows the estimated positions of the devices after fixing the position of device 4 and running one iteration of the positioning algorithm. It is noted, that after fixing the position of device 4, the position estimates for devices 1, 2, 3, 5, 6 and 7 are wrong (shown with dash lines in FIG. 6) and the estimate for device 8 is correct-like (shown with a square in FIG. 6). It is realized that the position estimate needs not to be exactly correct, but can vary slightly around the correct position. FIGS. 7, 8 and 9 show the position estimates after fixing additional device positions and running more iterations of the algorithms. After four iterations, the algorithm has found the correct position for all devices. This is shown in FIG. 9.

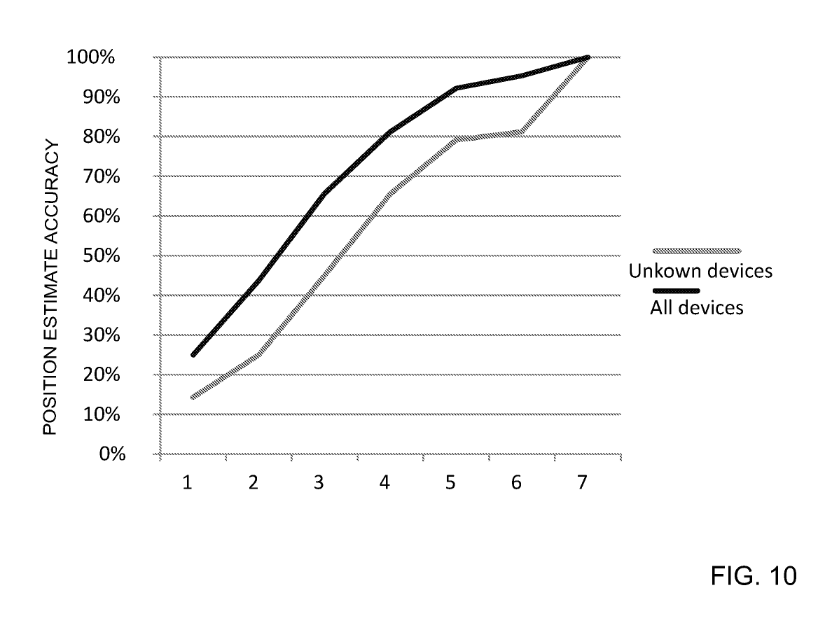

In an embodiment, the algorithm runs until seven devices positions are known and then repeated eight times. For each repetition, a different device was used to ask the first position. FIG. 10 shows the average accuracy of the position estimates for the eight tests for each iteration of the algorithm. The gray line (lower line) shows the accuracy being calculated as the percentage of correctly positioned devices, whose positions are not yet fixed. The black line (i.e. the upper line) shows the accuracy over all devices (including the ones whose positions are not known). So for example, the average accuracy for the devices with unfixed positions after four iterations is 66%. This means that the position of four (fixed) devices are known and on average 66% of the position of the remaining four. Therefore, actually positions of 83% of all devices are known.

It is to be noticed that the algorithm, as described above, assumes that no devices are in the same grid cells as the “anchor devices” (see step 5 of the algorithm). This assumption can be removed by changing the definition of the “close” grid cells so that the cell of the “anchor device” is also considered as a “close” grid cell.

In the previous a method for relative positioning was explained so that the positioning algorithm was carried out by a server. It is to be noticed that the solution can also be performed without a server, so that one or more of the devises run the positioning algorithm. The signal strengths are thus gathered by a device/devices in question. In order to share the signal strength data between devices, a following information sharing method can be utilized.

This information sharing method uses a “FriendlyName” information that is transmitted by and between Bluetooth devices. Such a method can be used, for example, for relative positioning without client-server architecture. In a nutshell, the method works by having the devices change their Bluetooth “FriendlyNames” to convey information, such as signal strengths, to each other. The method is explained in more detail below.

Each Bluetooth device can transmit its name in a “FriendlyName” field, and this can be set by the user or the software. This name appears when other Bluetooth devices scan for surrounding Bluetooth devices.

In this information sharing method, the “FriendlyName” can be modified in a way that information can be shared to other users. Some different embodiments are presented below:

In the first embodiment the client device may scan all the nearby device names, append them along with the received signal strength indicator value to its own “FriendlyName”. For example: FriendlyName: Device1: Device2; −95 dBm: Device3; −90 dBm. Such a name will then appear when other devices scan Device 1. The information in the “FriendlyName” can be used to solve the relative positions of each device, as all the link strengths become visible for all the devices. Device1 alone cannot determine the link strength between Device2 and Device3, but it can see it from the modified FriendlyName of Device2 or Device3. This embodiment can be utilized by the method for relative positioning being disclosed above so that no server is needed for making the positioning calculations.

In the second embodiment the client may scan all the nearby device names, append them along with some information field, such as classified motion mode of each device, to its own “FriendlyName”. For example: FriendlyName: Device1; standing: Device2; walking: Device3; table. This way the devices that cannot hear Device3 (for example) can still see the information via the “FriendlyName” of Device1. In addition to the motion mode of the devices, also user indicated position information such as the one being used in the method for relative positioning disclosed above can be sent between devices.

The use of the first and second embodiments being disclosed above for the relative positioning method is presented next. This is done in two parts: First, the radio fingerprint information is collected from all of the devices using the first embodiment. Second, the user feedback is obtained using the second embodiment.

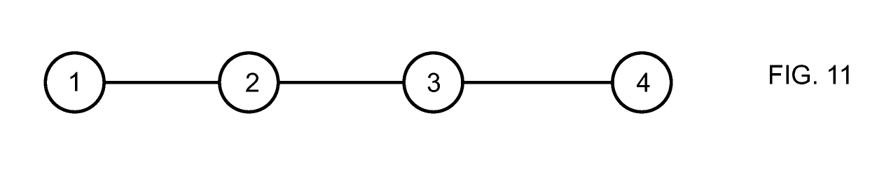

FIG. 11 shows an example how the radio fingerprint information is distributed between all devices. FriendlyNames of the devices indicate the signal strength the other devices being obtained by scanning the devices (i.e. first iteration). It is to be noticed that instead of the signal strength also motion mode of embodiment 2 can be indicated according to following steps:
Device 1 FriendlyName: “D1:D2 −50 dBm, D3 −80 dBm”
Device 2 FriendlyName: “D2:D1 −48 dBm, D3 −53 dBm, D4 −75 dBm”
Device 3 FriendlyName: “D3:D1 −74 dBm, D2 −53 dBm, D4 −55 dBm”
Device 4 FriendlyName: “D4:D2 −71 dBm, D3 −49 dBm”

During the second iteration, each device modifies its own FriendlyName by information being received from the FriendlyName of another device that is being heard by the device in question, for example, the FriendlyName of Device 1 is appended with information obtained from FriendlyName of Device 2 and Device 3. Modified FriendlyNames are as follows (added information is bolded):

Device 1 FriendlyName: “D1:D2 −50 dBm, D3 −80 dBm|D2:D1 −48 dBm, D3 −53 dBm, D4 −75 dBm D3:D1 −74 dBm, D2 −53 dBm, D4 −55 dBm”

Device 2 FriendlyName: “D2:D1 −48 dBm, D3 −53 dBm, D4 −75 dBm|D1:D2 −50 dBm, D3 −80 dBm D3:D1 −74 dBm, D2 −53 dBm, D4 −55 dBm D4:D2 −71 dBm, D3 −49 dBm”

Device 3 FriendlyName: “D3:D1 −74 dBm, D2 −53 dBm, D4 −55 dBm|D1:D2 −50 dBm, D3 −80 dBm D2:D1 −48 dBm, D3 −53 dBm, D4 −75 dBm D4:D2 −71 dBm, D3 −49 dBm”

Device 4 FriendlyName: “D4:D2 −71 dBm, D3 −49 dBm|D2:D1 −48 dBm, D3 −53 dBm, D4 −75 dBm D3:D1 −74 dBm, D2 −53 dBm, D4 −55 dBm”

During the third information, each device modifies its own FriendlyName further by adding the missing (not being seen during the second iteration) information being obtainable from the other devices' FriendlyName. In this example, FriendlyName of Device 1 is modified to include also signal strength of Device 4 and vice versa follows (added information is bolded):

Device 1 FriendlyName: “D1:D2 −50 dBm, D3 −80 dBm|D2:D1 −48 dBm, D3 −53 dBm, D4 −75 dBm D3:D1 −74 dBm, D2 −53 dBm, D4 −55 dBm|D4:D2 −71 dBm, D3 −49 dBm”

Device 2 FriendlyName: “D2:D1 −48 dBm, D3 −53 dBm, D4 −75 dBm|D1:D2 −50 dBm, D3 −80 dBm D3:D1 −74 dBm, D2 −53 dBm, D4 −55 dBm D4:D2 −71 dBm, D3 −49 dBm”

Device 3 FriendlyName: “D3:D1 −74 dBm, D2 −53 dBm, D4 −55 dBm|D1:D2 −50 dBm, D3 −80 dBm D2:D1 −48 dBm, D3 −53 dBm, D4 −75 dBm D4:D2 −71 dBm, D3 −49 dBm”

Device 4 FriendlyName: “D4:D2 −71 dBm, D3 −49 dBm|D2:D1 −48 dBm, D3 −53 dBm, D4 −75 dBm D3:D1 −74 dBm, D2 −53 dBm, D4 −55 dBm|D1:D2 −50 dBm, D3 −80 dBm”

In this example, after three iterations all devices know the Bluetooth signal strengths between all pairs of devices. It is appreciated that instead of the Bluetooth signal, also WLAN signal or other signal from other radio receivers can be used. In an embodiment, after the radio fingerprint information has been collected, we need to collect user feedback, from one user at a time, to obtain more reliable positioning. This is explained next. No more fingerprint information needs to be collected.

FIG. 11 is again used for user feedback collection. Now, Device 1 has been selected as the device which does the positioning calculations and is the one that initiates the asking of user feedback for device 3.

First iteration: Device 1 initiates query for device 3 position:
Device 1 FriendlyName: “Request position for device 3, iteration 1”
Device 2 FriendlyName: “”
Device 3 FriendlyName: “”
Device 4 FriendlyName: “”

Second iteration: Request is passed to devices 2 and 3 (device 4 cannot see request yet):
Device 1 FriendlyName: “Request position for device 3, iteration 1”
Device 2 FriendlyName: “Request position for device 3, iteration 1”
Device 3 FriendlyName: “Request position for device 3, iteration 1”
Device 4 FriendlyName: “”

Third iteration: Device 3 sees request for its position and asks its user to input or indicate its position. After having the position, Device 3 updates its FriendlyName to reflect the obtained position. Device 4 finally sees request (from devices 2 and 3):
Device 1 FriendlyName: “Request position for device 3, iteration 1”
Device 2 FriendlyName: “Request position for device 3, iteration 1”
Device 3 FriendlyName: “Device 3 position (3, 1), iteration 1”
Device 4 FriendlyName: “Request position for device 3, iteration 1”

Fourth iteration: All devices see device 3 sharing its position. Device 1 notices the position and performs the positioning calculations again:
Device 1 FriendlyName: “Device 3 position (3, 1), iteration 1”
Device 2 FriendlyName: “Device 3 position (3, 1), iteration 1”
Device 3 FriendlyName: “Device 3 position (3, 1), iteration 1”
Device 4 FriendlyName: “Device 3 position (3, 1), iteration 1”

In the previous embodiments, no pairing or bonding is required, only a software that changes the “FriendlyNames” accordingly. This can be possibly used with other radio transmission systems/protocols as well—not only Bluetooth. Some known checksum method can be added to the name, to prevent copying “FriendlyNames” of devices that do not have the program installed, or to prevent spoofing attacks.

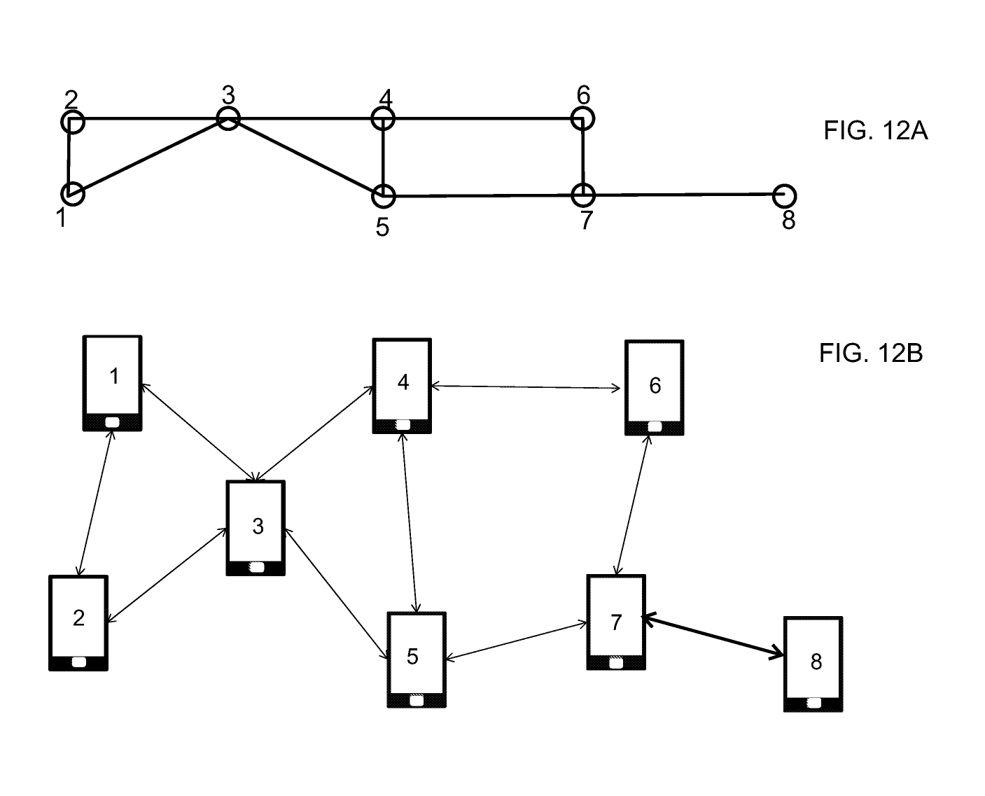

FIGS. 12A and 12B show yet a further example for sharing information between devices. In the example of FIGS. 12A and 12B, there are eight devices, having the numbers 1 to 8 as their names. Lines between the devices show the connections between the devices.

In this example, the FriendlyNames have fields, so that the links can be tracked. These fields are separated by some character and the device name is at the beginning. The initial state is as follows:
Device 1 FriendlyName: ‘1’ ″ ″ ″ ″ ″
Device 2 FriendlyName: ‘2’ ″ ″ ″ ″ ″
Device 3 FriendlyName: ‘3’ ″ ″ ″ ″ ″
Device 4 FriendlyName: ‘4’ ″ ″ ″ ″ ″
Device 5 FriendlyName: ‘5’ ″ ″ ″ ″ ″
Device 6 FriendlyName: ‘6’ ″ ″ ″ ″ ″
Device 7 FriendlyName: ‘7’ ″ ″ ″ ″ ″
Device 8 FriendlyName: ‘8’ ″ ″ ″ ″ ″

In this example, each field shows how many links there are to reach the device in question. Then each device copies the fields from the other devices, but to the field that is one step larger. Then, duplicates may be removed to avoid too long names (“FriendlyName” length is limited).

By carrying out the method, after the first iteration, the device “FriendlyNames” are as follows:
Device 1 FriendlyName: ‘1’ ‘23’ ″ ″ ″ ″
Device 2 FriendlyName: ‘2’ ‘13’ ″ ″ ″ ″
Device 3 FriendlyName: ‘3’ ‘1245’ ″ ″ ″ ″
Device 4 FriendlyName: ‘4’ ‘356’ ″ ″ ″ ″
Device 5 FriendlyName: ‘5’ ‘347’ ″ ″ ″ ″
Device 6 FriendlyName: ‘6’ ‘47’ ″ ″ ″ ″
Device 7 FriendlyName: ‘7’ ‘568’ ″ ″ ″ ″
Device 8 FriendlyName: ‘8’ ‘7’ ″ ″ ″ ″

These “FriendlyNames” indicate which devices are one hop away from the device in question. This means that two devices have a direct link with each other and do not have any other device therein between. For example, it is realized that Device 1 is one hop away from Devices 2 and 3. On the other hand, Device 5 is one hop away from Devices 3, 4 and 7.

The second iteration provides following:
Dev1 FriendlyName: ‘1’ ‘23’ ‘45’ ″ ″ ″
Dev2 FriendlyName: ‘2’ ‘13’ ‘45’ ″ ″ ″
Dev3 FriendlyName: ‘3’ ‘1245’ ‘67’ ″ ″ ″
Dev4 FriendlyName: ‘4’ ‘356’ ‘127’ ″ ″ ″
Dev5 FriendlyName: ‘5’ ‘347’ ‘1268’ ″ ″ ″
Dev6 FriendlyName: ‘6’ ‘47’ ‘358’ ″ ″ ″
Dev7 FriendlyName: ‘7’ ‘568’ ‘34’ ″ ″ ″
Dev8 FriendlyName: ‘8’ ‘7’ ‘56’ ″ ″ ″

Now, the “FriendlyNames” show, which devices are two hops away from the device in question. This means that devices being two hops/links away are reachable via another terminal being located between the device in question and the device being two hops way. For example, Device 3 is two hops away from devices 6 and 7, whereas Device 8 is two hops away from devices 5 and 6.

The third iteration provides following:
Device 1 FriendlyName: ‘1’ ‘23’ ‘45’ ‘67’ ″ ″
Device 2 FriendlyNname: ‘2’ ‘13’ ‘45’ ‘67’ ″ ″
Device 3 FriendlyName: ‘3’ ‘1245’ ‘67’ ‘8’ ″ ″
Device 4 FriendlyName: ‘4’ ‘356’ ‘127’ ‘8’ ″ ″
Device 5 FriendlyName: ‘5’ ‘347’ ‘1268’ ″ ″ ″
Device 6 FriendlyName: ‘6’ ‘47’ ‘358’ ‘12’ ″ ″
Device 7 FriendlyName: ‘7’ ‘568’ ‘34’ ‘12’ ″ ″
Device 8 FriendlyName: ‘8’ ‘7’ ‘56’ ‘34’ ″ ″

After four iterations the names are:
Device 1 FriendlyName: ‘1’ ‘23’ ‘45’ ‘67’ ‘8’ ″
Device 2 FriendlyName: ‘2’ ‘13’ ‘45’ ‘67’ ‘8’ ″
Device 3 FriendlyName: ‘3’ ‘1245’ ‘67’ ‘8’ ″ ″
Device 4 FriendlyName: ‘4’ ‘356’ ‘127’ ‘8’ ″ ″
Device 5 FriendlyName: ‘5’ ‘347’ ‘1268’ ″ ″ ″
Device 6 FriendlyName: ‘6’ ‘47’ ‘358’ ‘12’ ″ ″
Device 7 FriendlyName: ‘7’ ‘568’ ‘34’ ‘12’ ″ ″
Device 8 FriendlyName: ‘8’ ‘7’ ‘56’ ‘34’ ‘12’ ″

Showing correctly the link information, Device 1 is four hops away from the Device 8. This means that devices being four hops/links away are reachable via three other terminals being located between the device in question and the device being four hops way. This information can be read form the Device 8 Name directly. No information payload is attached to this example.

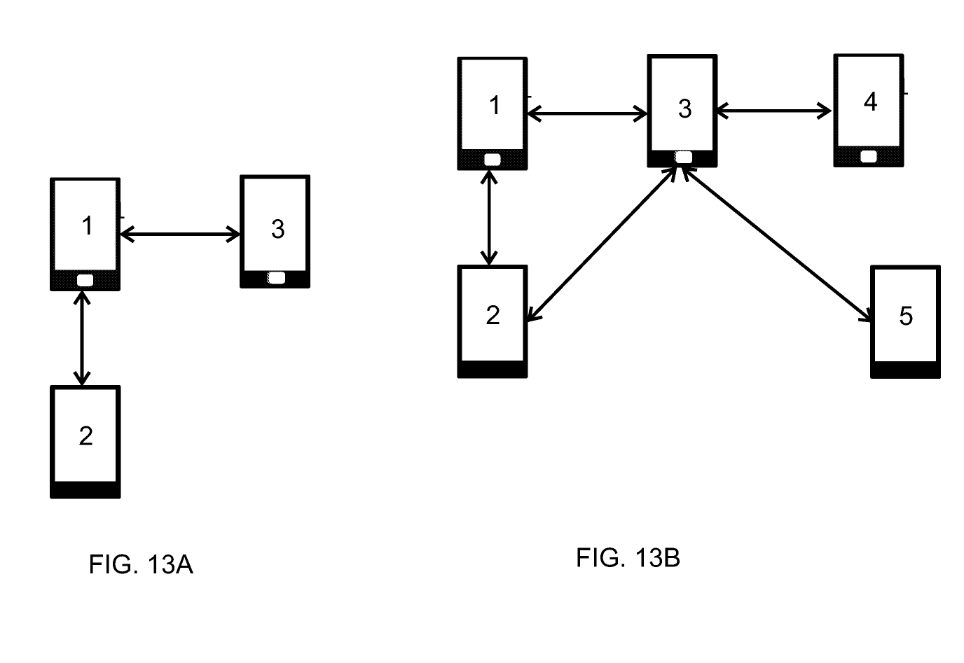

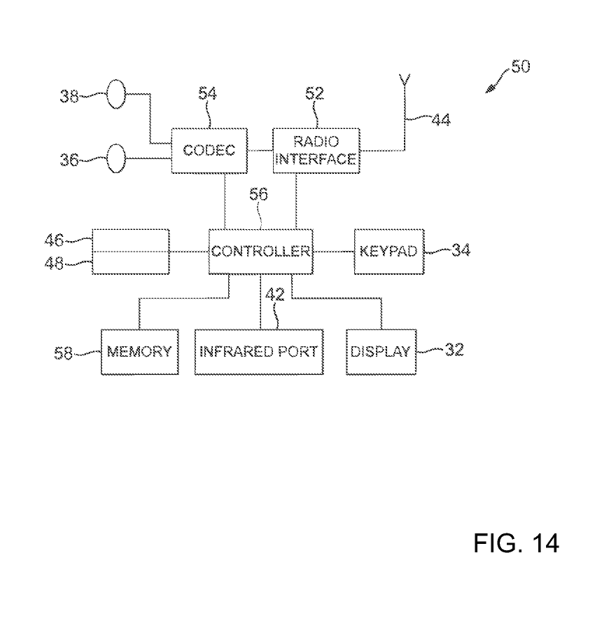

FIGS. 13A and 13B show the first two iterations from the point of view of Device 1. In the first iteration (FIG. 13A) the Device 1 hears Device 2 and Device 3, whereby Device 1 changes its name to ‘1 23’. At same iteration round Device 2 is capable of changing its name to ‘2 13’ and Device 3 is capable of changing its name to ‘3 1245’. In the second iteration (FIG. 13B) Device 1 sees from the names of Device 2 and Device 3 what Device 2 and Device 3 hear, whereby Device 1 is capable of changing its name to ‘1 23 45’ by copying the information from the names of Device 2 and Device 3 and removing duplicates, whereby Devices 4 and 5 are added to “FriendlyName” of Device 1. The similar procedure is made by each Device 1 to 8 presented in FIGS. 11 and 12 in order to obtain the complete “FriendlyNames”.

Since in some embodiments, the algorithm may work iteration by iteration, the devices may need to be synchronized so that they are performing the same iteration round with each other. For example, the devices don not start the next round until each of the devices has completed the current iteration round. Synchronizing information can be added to the “FriendlyNames” of the devices, i.e. the iteration number of the algorithm that the device is performing is included in the “FriendlyName” of the device. Synchronizing can also be done using a timer such that devices start performing iteration of the algorithm at set time intervals.

The following describes in further detail suitable apparatus and possible mechanisms for implementing the embodiments of the invention. In this regard reference is first made to FIG. 14 which shows a schematic block diagram of an exemplary apparatus or electronic device 50.

The electronic device 50 may for example be a mobile terminal or user equipment of a wireless communication system. However, it would be appreciated that embodiments of the invention may be implemented within any electronic device or apparatus having at least one radio receiver. Examples of such electronic devices include personal digital assistants (PDAs), pagers, mobile televisions, mobile telephones, gaming devices, laptop computers, tablet computers, personal computers (PCs), cameras, camera phones, video recorders, audio/video players, radios, global positioning system (GPS) devices, or any combination of the aforementioned.

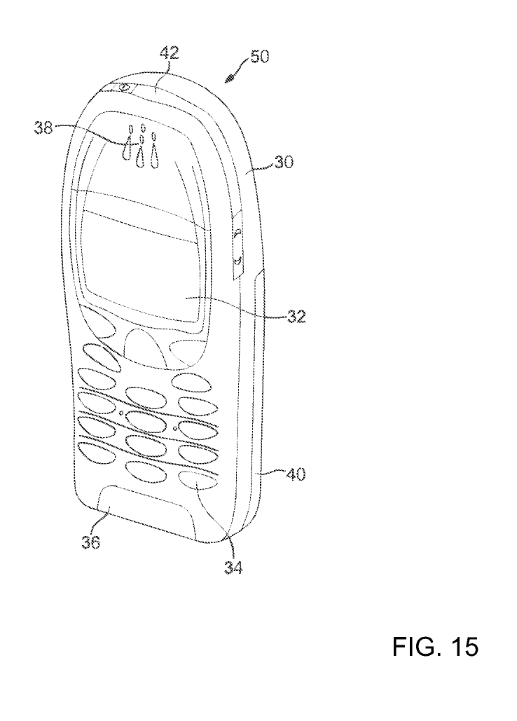

The apparatus 50 may comprise a housing 30 (see FIG. 15) for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display or voice recognition system. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise an infrared port 42 for short range line of sight communication to other devices. In other embodiments the apparatus 50 may further comprise any suitable short range communication solution such as for example a Bluetooth wireless connection or a USB/firewire wired connection.

Referring back to FIG. 14, the apparatus 50 may comprise a controller 56 or processor for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

The apparatus 50 may comprise a camera capable of recording or detecting individual frames which are then passed to the codec 54 or controller for processing. In other embodiments of the invention, the apparatus may receive the video image data for processing from another device prior to transmission and/or storage. In other embodiments of the invention, the apparatus 50 may receive either wirelessly or by a wired connection the image for coding/decoding.

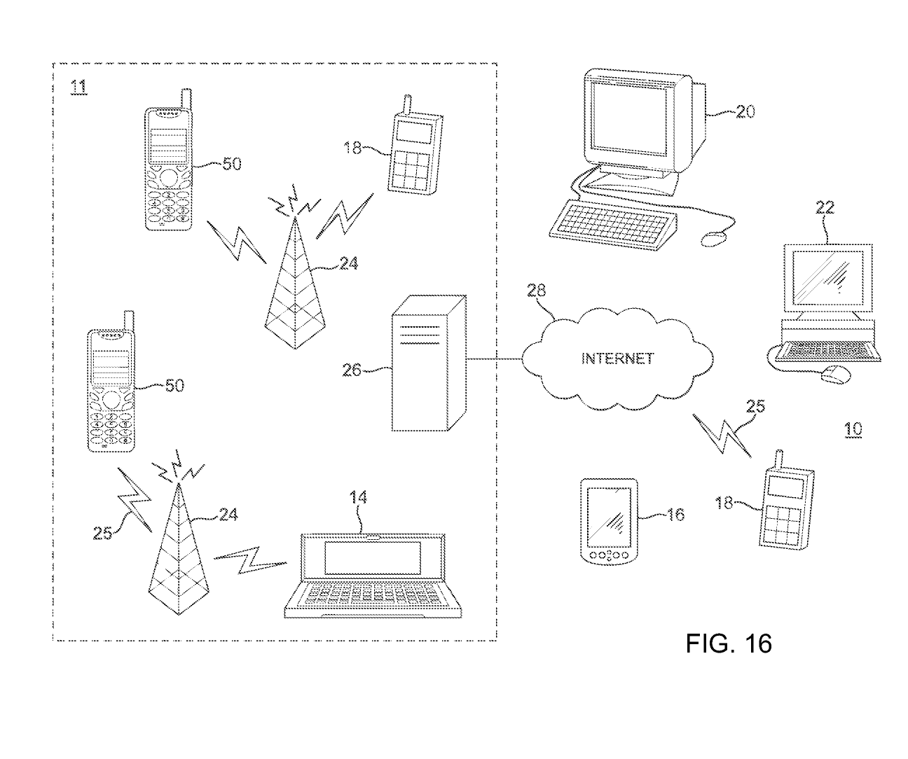

With respect to FIG. 16, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices or apparatus 50 suitable for implementing embodiments of the invention.

For example, the system shown in FIG. 16 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

Without in any way limiting the scope, interpretation, or application of the claims appearing below, a technical effect of one or more of the example embodiments disclosed herein is to have a solution, by means of which makes giving feedback on user position is simple and puts minimum burden for users. Another technical effect of one or more of the example embodiments disclosed herein is to have a fast algorithm for determine the relative positions of users indoors. Another technical effect of one or more of the example embodiments disclosed herein is to share position information between devices without a server.

Embodiments of the present invention may be implemented in software, hardware, application logic or a combination of software, hardware and application logic. The software, application logic and/or hardware may reside on memory of the device. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIGS. 14 and 15. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-37. (canceled)

38. A method, comprising:
a) receiving information relating to radio fingerprint of an apparatus from at least two apparatus;
b) determining estimated positions of said at least two apparatus according to received information;
c) selecting an apparatus from said at least two apparatus;
d) requesting information relating to position of the selected apparatus;
e) iterating the steps b), c) and d) until estimated positions are determined to be reliable.

39. The method according to claim 38, further comprising
determining which apparatus has the least reliable estimated position and selecting such an apparatus from said at least two apparatus.

40. The method according to claim 38, further comprising
requesting the selected apparatus to indicate its position in the form of an identification of a grid cell; or
requesting the selected apparatus to indicate its position in the form of radio fingerprint.

41. The method according to claim 40, further comprising
receiving information in the form of user input.

42. The method according to claim 38, wherein the radio fingerprint data is formed of any of the following elements independently or in combination: one or more device addresses used for one or more type of data transmission, one or more signal strengths relating to certain data transmission method.

43. The method according to claim 38, further comprising
forming a matrix comprising the received fingerprints of said at least two apparatus relating to a certain data transmission method in order to determine the estimated positions of the apparatuses.

44. The method according to claim 38, wherein for determining that the estimated positions are reliable, the method further comprising
i) creating position probability matrices for said at least two apparatus, which position probability matrices relate to a certain data transmission method indicating the estimated position for said at least two apparatus,
ii) determining mean matrix for said at least two apparatus by means of the position probability matrices, and
repeating steps i) and ii) until probabilities for unknown positions are above a threshold.

45. The method according to claim 38, wherein the information relating to radio fingerprints or position is shared between said at least two apparatus by modifying names of the apparatuses to comprise information on radio fingerprints of surrounding apparatuses, and repeating this until information relating to each apparatus of said at least two apparatus has been obtained.

46. A method for sharing information between devices for positioning purposes, comprising
scanning nearby device names;
modifying an own name field so that the name field contains information on the scanned nearby device names.

47. An apparatus, comprising:
at least one processor; and
at least one memory including computer program code;
the at least one memory and the computer program code configured to, with the at least one processor, cause the apparatus to perform at least the following:
a) receive information relating to radio fingerprint of an apparatus from at least two apparatus;
b) determine estimated positions of said at least two apparatuses according to received information;
c) select an apparatus from said at least two apparatuses;
d) request information relating to position of the selected apparatus;
e) iterate b), c) and d) until estimated positions are determined to be reliable.

48. The apparatus according to claim 47, further comprising computer program code configured to, with the processor, cause the apparatus to perform at least the following:
determine which apparatus has the least reliable estimated position and selecting such an apparatus from said at least two apparatuses.

49. The apparatus according to claim 47, further comprising computer program code configured to, with the processor, cause the apparatus to perform at least one of the following:
request the selected apparatus to indicate its position in the form of an identification of a grid cell; and
request the selected apparatus to indicate its position in the form of radio fingerprint.

50. The apparatus according to claim 49, further comprising computer program code configured to, with the processor, cause the apparatus to perform at least the following:
receive information in the form of user input.

51. The apparatus according to claim 47, wherein the radio fingerprint data is formed of any of the following elements independently or in combination: one or more device addresses used for one or more type of data transmission, one or more signal strengths relating to certain data transmission method.

52. The apparatus according to claim 47, further comprising computer program code configured to, with the processor, cause the apparatus to perform at least the following:
form a matrix comprising the received fingerprints of said at least two apparatuses relating to a certain data transmission method in order to determine the estimated positions of the apparatuses.

53. The apparatus according to claim 47, wherein for determining that the estimated positions are reliable, the apparatus further comprising computer program code configured to, with the processor, cause the apparatus to perform at least the following:
i) create position probability matrices for said at least two apparatus, which position probability matrices relate to a certain data transmission method indicating the estimated position for said at least two apparatus,
ii) determine a mean matrix for said at least two apparatus by means of the position probability matrices, and
repeat i) and ii) until probabilities for unknown positions are above a threshold.

54. The apparatus according to claim 47, wherein the information relating to radio fingerprints or position is shared between said at least two apparatus by modifying names of the apparatuses to comprise information on radio fingerprints of surrounding apparatuses, and repeating this until information relating to each apparatus of said at least two apparatus has been obtained.

55. The apparatus according to claim 47, wherein the apparatus comprises a communication device comprising:
a user interface circuitry and user interface software configured to facilitate a user to control at least one function of the communication device through use of a display and further configured to respond to user inputs; and
a display circuitry configured to display at least a portion of a user interface of the communication device, the display and display circuitry configured to facilitate the user to control at least one function of the communication device.

56. An apparatus, comprising:
at least one processor; and
at least one memory including computer program code;
the at least one memory and the computer program code configured to, with the at least one processor, cause the apparatus to perform at least the following:
scan nearby device names
modify an own name field so that the name field contains information on the scanned nearby device names
in order to share information between devices for positioning purposes.

57. A computer program product comprising a computer-readable medium comprising computer program code which when executed by an apparatus, cause the apparatus to:
a) receive information relating to radio fingerprints of an apparatus from at least two apparatus;
b) determine estimated positions of said at least two apparatus according to received information;
c) select an apparatus from at least two apparatus;
d) request information relating to position of the selected apparatus;
iterate b), c) and d) until estimated positions are determined to be reliable.
